(19) United States
(12) Patent Application Publication
(10) Pub. No.: US 2026/0331527 A1
(43) Pub. Date: Oct. 22, 2026

(54) AN ELECTRODE FOR A REDOX BATTERY AND PROCESS FOR PREPARING THEREOF

(71) Applicant: OFFGRID ENERGY LABS INC., San Francisco, CA (US)

(72) Inventors: Brindan Tulachan, Noida (IN); Sumanta Chakrabarty, Noida (IN)

(21) Appl. No.: 19/122,762

(22) PCT Filed: Oct. 17, 2023
(86) PCT No.: PCT/IN2023/050950

§ 371 Date: Apr. 21, 2025

(30) Foreign Application Priority Data
Oct. 21, 2022 (IN) 202211060380

(51) Int. Cl. H01M 4/96; H01M 4/86; H01M 4/88

(52) U.S. Cl. CPC H01M 4/96; H01M 4/8652; H01M 4/8668; H01M 4/8875; H01M 4/8882

(57) ABSTRACT

An electrode for a redox battery is provided. The electrode includes activated carbon, conductive carbon black, milled carbon fiber, and PTFE binder. The electrode is highly conductive mainly due to the uniform distribution of the conductive carbon black. The electrode has high surface area compared to conventional electrode. The electrode exhibits desirable mechanical strength, flexibility and load resistance capabilities. The present invention also provides the process for preparing the electrode for the redox battery. The process involves development of a flexible composite electrode with high conductivity, increased surface area, and suitable for energy storage applications. The process provided by the present invention is simple, cost-effective, and scalable.

### EARLIEST PRIORITY DATE

This application claims priority from a Complete patent application filed in India having patent application No. 202211060380, filed on Oct. 21, 2022, and titled “AN ELECTRODE FOR A REDOX BATTERY AND PROCESS FOR PREPARING THEREOF” and a PCT application bearing application no. PCT/IN2023/050950, filed on Oct. 17, 2023 and titled “AN ELECTRODE FOR A REDOX BATTERY ANDPROCESS FOR PREPARING THEREOF”.

### FIELD OF INVENTION

Embodiment of the present invention relates to high-capacity electrode active materials for redox batteries and more particularly it relates to an electrode for a redox battery and process for preparing thereof.

### BACKGROUND

A redox battery (RB) is an electrochemical device that utilizes the potential difference between a set of redox couples, typically solution based, to interconvert chemical and electrical energy via reduction and oxidation at the respective electrodes. However, electrodes of RB provide low energy density, lower surface area, undesired transition of the electrolytes through the membrane, and are expensive.

Recent studies have revealed use of fibrillated Poly(tetrafluoroethylene) (PTFE) binder to strengthen the electrode sheet and overcome the aforementioned issues. However, Fibrillation introduces unnecessary steps and requires higher energy (higher shear forces). The fibrillation may cause agglomeration of the PTFE binder. If the fibrils agglomerate, the effectiveness of the PTFE as a binder is reduced. To avoid agglomeration a wetting agent may be required. However, removal of such wetting agent from the electrode sheet requires high temperature (>290° C.).

Moreover, use of very fine activated carbon particles can result in electrodes with high capacitance and such compositions also require the fibrillated polymeric binder which essentially involves very high shear during processing to form an interconnecting web of fibers that will hold the fine carbon particles together. Thus, making the process complicated and expensive. On the other hand, very coarse activated carbon particles can be bound by thermoplastic polymeric binder to form electrodes however they have relatively low capacitance, although the process is simple.

Hence, there is a need for cost-effective electrodes with high surface area and longer life, and a process for preparing thereof.

### SUMMARY

In accordance with an embodiment of the present invention, an electrode for a redox battery is provided. The electrode includes an electrode sheet. The electrode sheet comprises one of a cathode electrode sheet and an anode electrode sheet. The cathode electrode sheet comprises an electrode mixture with a solvent in a wt:vol ratio ranging from 1:2 to 1:3. The anode electrode sheet comprises the electrode mixture with the solvent in a wt:vol ratio ranging from 1:3 to 1:4. The electrode mixture comprises 50-70 wt % of activated carbon, 20-40 wt % of conductive carbon black, 1 to 10 wt % of milled carbon fiber and 0.5 to 2 wt % of PTFE binder.

In accordance with another embodiment of the present invention, a process for preparing an electrode for the redox battery is provided. The process includes adding 1.5 wt % of PTFE binder to a first solvent to obtain a homogeneous dispersion. The process also includes mixing 50-70 wt % of activated carbon, 20-40 wt % of conductive carbon black and 1 to 10 wt % of milled carbon fiber to obtain a solid mixture. The process includes uniformly mixing the homogeneous dispersion and the solid mixture for a duration of 2 hours to obtain an electrode mixture. The process also includes drying the electrode mixture at 120° C. for a duration of 12 hours. The process also includes mixing the dried electrode mixture with a second solvent in a predefined ratio to obtain an electrode paste. The predefined ratio is a wt:vol ratio ranging from 1:2 to 1:3 to obtain a cathode electrode paste. The predefined ratio is a wt:vol ratio ranging from 1:3 to 1:4 to obtain an anode electrode paste. The process further includes subjecting the electrode paste to compaction to obtain an electrode sheet. The process also includes drying the electrode sheet at 50 to 65° C. for a duration of 12 hours to obtain the electrode for the redox battery.

To further clarify the advantages and features of the present invention, a more particular description of the invention will follow by reference to specific embodiments thereof, which are illustrated in the appended figures. It is to be appreciated that these figures depict only typical embodiments of the invention and are therefore not to be considered limiting in scope. The invention will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a pictorial representation of an electrode, in accordance with an embodiment of the present invention;

FIG. 2 is a microscopic image of the electrode, in accordance with an embodiment of the present invention;

FIG. 3 illustrates a flow diagram representing steps involved in a process for preparing the electrode for redox battery, in accordance with an embodiment of the present invention;

FIG. 4 is pictorial representation of steps involved in the process for preparing the electrode for redox battery;

FIG. 5 is representation of cyclic voltammogram of the electrode, in accordance with an embodiment of the present invention; and

FIG. 6 is representation of galvanostatic cycling data of the electrode a) Potential vs Capacity, b) Voltage vs Time, and c) Coulombic efficiency (%) vs Capacity retention (%), in accordance with an embodiment of the present invention.

Further, those skilled in the art will appreciate that elements in the figures are illustrated for simplicity and may not have necessarily been drawn to scale. Furthermore, in terms of the method steps, chemical compounds, equipments and parameters used herein may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE PRESENT INVENTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more components, compounds, and ingredients preceded by “comprises . . . a” does not, without more constraints, preclude the existence of other components or compounds or ingredients or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present invention relates to an electrode for a redox battery. The invention mainly focuses on development of a flexible composite electrode with high conductivity, increased surface area, and suitable for energy storage applications such as electrodeposition deionization (water treatment).

In an embodiment, the electrode for a redox battery is provided. The electrode includes an electrode sheet. The electrode sheet includes one of a cathode electrode sheet and an anode electrode sheet.

The cathode electrode sheet comprises an electrode mixture with a solvent in a wt:vol ratio varying from 1:2 to 1:3. The solvent is selected from a group consisting of ethanol, isopropanol, and a combination thereof. The cathode electrode sheet comprises a thickness of 2 to 5 mm. In one exemplary embodiment, the cathode electrode sheet preferably includes the electrode mixture with the solvent in the wt:vol ratio of 1:2.5. In another exemplary embodiment, the anode electrode sheet preferably includes the electrode mixture with the solvent in the wt:vol ratio of 1:3.5.

As used herein the term “cathode electrode sheet” refers to a positive or oxidizing electrode that acquires electrons from the external circuit and is reduced during the electrochemical reaction.

The anode electrode sheet includes the electrode mixture with the solvent in a wt:vol ratio ranging from 1:3 to 1:4. The solvent is selected from a group consisting of ethanol, isopropanol, and a combination thereof. The anode electrode sheet comprises a thickness of 0.1 to 2 mm.

As used herein the term “anode electrode sheet” refers to an electrode of a device through which conventional current (positive charge) flows into the device from an external circuit.

The electrode mixture includes 50-70 wt % of activated carbon, 20-40 wt % of conductive carbon black, 1 to 10 wt % of milled carbon fiber and 0.5 to 2 wt % of PTFE binder. In one embodiment, the electrode mixture preferably includes 65 wt % of activated carbon, 25 wt % of conductive carbon black, 8.5 wt % of milled carbon fiber and 1.5 wt % of PTFE binder. In one embodiment, the electrode mixture includes 50-70 wt % of activated carbon, 20-40 wt % of conductive carbon black, and 0.5 to 2 wt % of PTFE binder. The electrode is configured to exhibit enhanced mechanical strength, flexibility and load resistance capabilities. The optimized ratio of composition involved in the electrode has capabilities to form a very thin i.e., ~0.4 mm strong and flexible composite electrode with desirable conductivity and surface area. In one embodiments, the cathode electrode sheet preferably includes the thickness of >2 mm.

As used herein the term “activated carbon” refers to an adsorbent derived from carbonaceous raw material, in which thermal or chemical means have been used to remove most of the volatile non-carbon constituents and a portion of the original carbon content, yielding a structure with high surface area. The activated carbon is used to purify liquids and gases in a variety of applications including municipal drinking water, food and beverage processing, odour removal, and industrial pollution control.

As used herein the term “conductive carbon black” refers a type of carbon, having a higher “graphitic character” of the surface. The term “graphitic character” is used here to describe how close the structure of the carbon black surface approaches the structure of a perfect graphite surface.

As used herein the term “milled carbon fiber” refers to a very short strand-length (100 μm) fibrous powder manufactured from recycled carbon fibre.

As used herein the term “PTFE binder” refers to a soft, low friction fluoropolymer with outstanding chemical resistance and weathering resistance. The PTFE binder is stable at temperatures up to 500° F. and it is often used in high temperature environments. The PTFE binder is widely used to prepare electrode materials for batteries, fuel cells and supercapacitors.

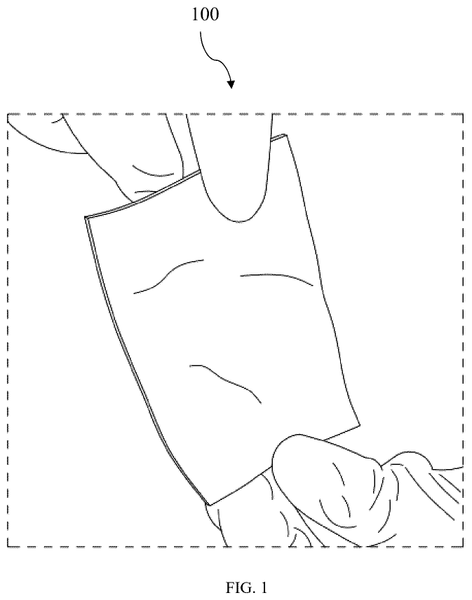

FIG. 1 is a pictorial representation of the electrode, in accordance with an embodiment of the present invention. FIG. 1 shows the electrode including 65 wt % of activated carbon, 25 wt % of conductive carbon black, 8.5 wt % of milled carbon fiber and 1.5 wt % of PTFE binder.

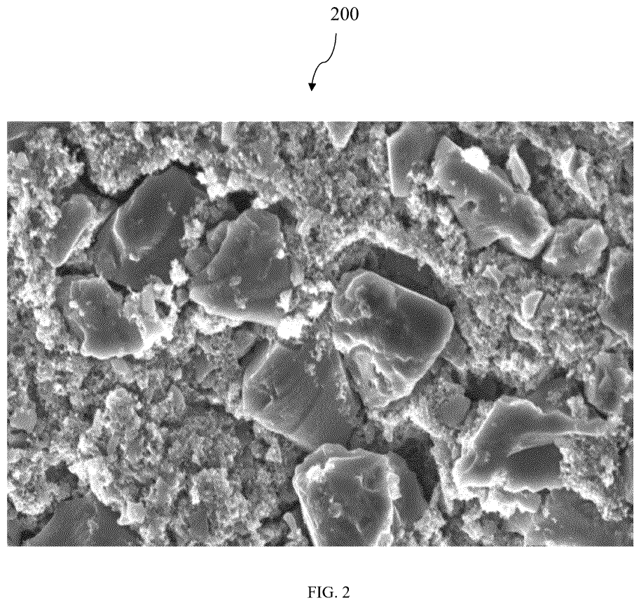

FIG. 2 is a microscopic image of the electrode, in accordance with an embodiment of the present invention. The microscopic image of the electrode shows surface of the electrode provided by the present invention.

In another embodiment of the present invention, a process for preparing an electrode for the redox battery is provided, the invention mainly involves formation of a composite matrix using conductive powder materials.

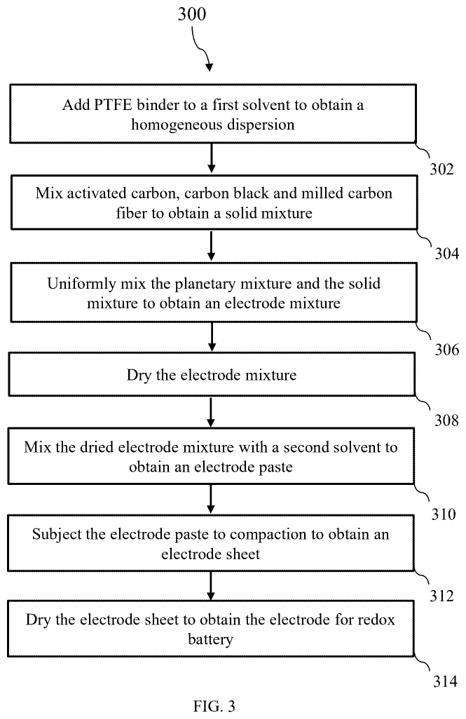

FIG. 3 illustrates a flow diagram representing steps involved in the process for preparing the electrode for redox battery, in accordance with an embodiment of the present invention.

The process for preparing the electrode begins with adding 1.5 wt % of PTFE binder to a first solvent to obtain a homogeneous dispersion at step 302. The first solvent includes water and one of ethanol and iso-propyl alcohol in a volume ratio of 8:2.

In one embodiment, the first solvent includes water and ethanol in the volume ratio of 8:2. In one embodiment, the first solvent includes water and iso-propyl alcohol in the volume ratio of 8:2.

In an embodiment, 50-70 wt % of activated carbon, 20-40 wt % of conductive carbon black and 1 to 10 wt % of milled carbon fiber are mixed to obtain a solid mixture at step 304. In one embodiment, the step 304 preferably comprises mixing of 65% of activated carbon, 25% of conductive carbon black and 8.5% of milled carbon fiber to obtain the solid mixture. In one embodiment, the solid mixture is prepared by mixing 50-70 wt % of activated carbon and 20-40 wt % of conductive carbon black i.e., without mixing the milled carbon fiber.

In an embodiment, the homogeneous dispersion and the solid mixture are uniformly mixed for a duration of 2 hours to obtain an electrode mixture at step 306. The uniform mixing provides high conductivity and surface area to the electrode.

In an embodiment, the electrode mixture is dried at 120° C. for a duration of 12 hours at step 308. The drying of the electrode mixture is carried out using a hot air oven.

In an embodiment, the dried electrode mixture is mixed with a second solvent in a predefined ratio to obtain an electrode paste at step 310. The predefined ratio is a wt:vol ratio ranging from 1:2 to 1:3 to obtain a cathode electrode paste. In one embodiment, the predefined ratio preferably includes the wt:vol ratio of 1:2.5 to obtain the cathode electrode paste. The predefined ratio is a wt:vol ratio ranging from 1:3 to 1:4 to obtain a cathode electrode paste. In one embodiment the predefined ratio preferably includes the wt:vol ratio of 1:3.5 to obtain an anode electrode paste.

In such an embodiment, the electrode paste is subjected to compaction to obtain an electrode sheet at step 312. In one embodiment, the cathode electrode paste is subjected to compaction using a hydraulic press followed by a roller to obtain a cathode electrode sheet. The cathode electrode sheet comprises a thickness of 2 to 5 mm. In one embodiment, the cathode electrode paste is subjected to compaction using the hydraulic press followed by a roller to obtain an anode electrode sheet. The anode electrode sheet comprises a thickness of 0.1 to 2 mm. The compaction may be carried out using the hydraulic press, an extruder or any similar equipment.

Further in an embodiment, the electrode sheet is dried at 50 to 65° C. for a duration of 12 hours to obtain the electrode for redox battery at step 314. The drying of the electrode sheet helps in removing moisture from the electrode sheet. The drying of the electrode sheet is carried out using the hot air oven.

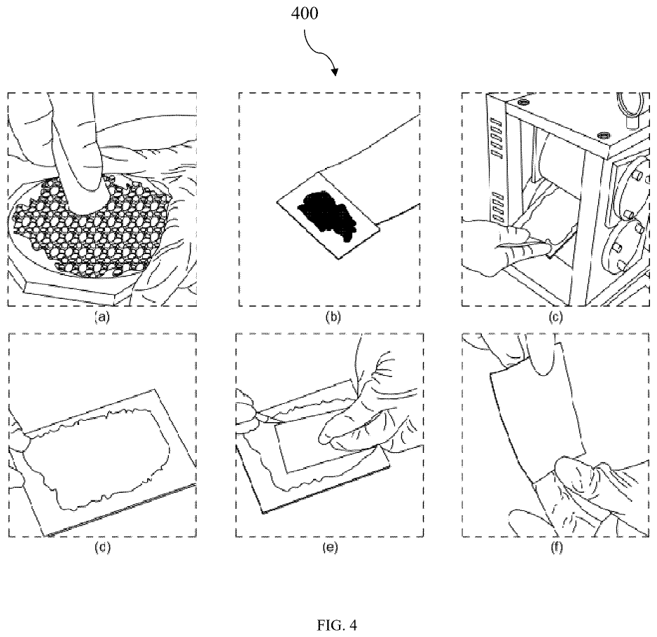

FIG. 4 is pictorial representation of steps involved in the process for preparing the electrode for redox battery.

Characterization studies are carried out for the prepared electrode in the present invention. Experiments carried are as follows:

### 1. Mechanical Strength Measurement:

The mechanical strength measurement is investigated using three electrode samples, and average values have been reported.

The young's modulus values have been calculated through a relationship between shore A hardness and young's modulus.

$$The correlation is E = \frac{0.0981 ( 56 + 7.66 s )}{0.137505 ( 254 + 2.54 s )}$$

Where, E is young's modulus in MPa and s is the shore hardness.

Table 1 enlists hardness value and Young's modulus (MPa) of the prepared electrodes.

TABLE 1

| | Electrode Composition | Average shore | Young's |
|---|---|---|---|
| SI | AC:CCB:CF:B - wt. | A hardness | modulus |
| no. | ratio | value | (MPa) |
| 1 | 72:25:0:3 | 0.67 ± 0.01 | 0.17 |
| 2 | 69.5:25:4:1.5 | 0.79 ± 0.006 | 0.18 |
| 3 | 65:33.5:0:1.5 | 0.68 ± 0.007 | 0.17 |

In the table 1 “AC” represents activated carbon, “CCB” represents conductive carbon black, “CF” represents carbon fiber, and “B” represents PTFE binder. The table 1 exhibit different electrode composition for redox batteries and their mechanical properties. The electrode composition 2 including the carbon fiber along with activated carbon, the conductive carbon black and PTFE binder shows increased hardness value and Young's modulus.

### 2. Electrochemical Analysis:

### Cyclic Voltammogram

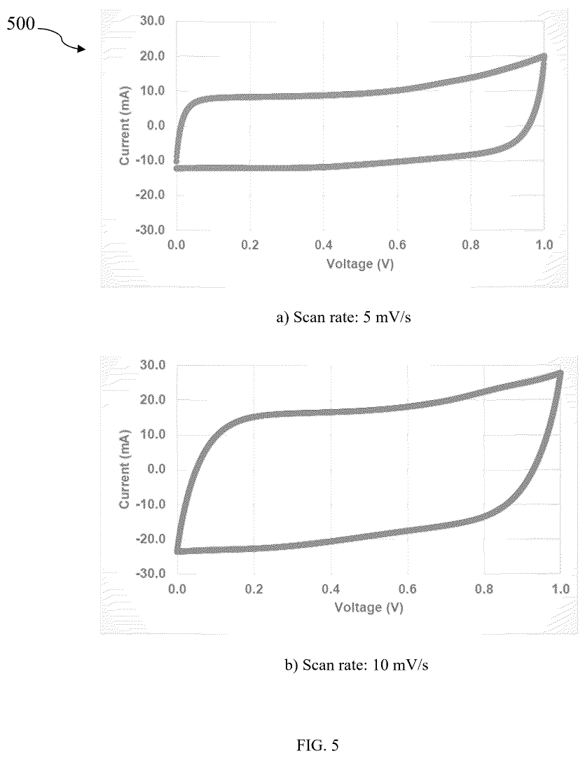

The cyclic voltammetry (CV) is a type of potentiodynamic electrochemical measurement. The working electrode potential is ramped linearly versus time. The current at the prepared electrode is plotted versus the applied voltage to give the cyclic voltammogram trace. The prepared electrode include 65 of wt. % of activated carbon, 25 wt % of conductive carbon black, 8.5% of carbon fiber, and 1.5% PTFE binder. 1M H₂SO₄ is used as an electrolyte for the experiment. Scan rate of 5 mV/s, 10 mV/s and 0 to 1 V potential range is used (shown in FIG. 5).

FIG. 5 is representation of cyclic voltammogram of the electrode, in accordance with an embodiment of the present invention. Almost rectangular voltammograms represent a signature of electric double layer capacitor (EDLC) due to the absence of such redox active species in electrode surface and electrolyte within the applied potential range. Further, this well-capacitive voltammogram indicates no limitation in pore accessibility within the electrode for the ions. As usual, at a higher scan rate, the diffusion rate is more than the rate of reaction. Therefore, the current at higher scan rate increases.

### Galvanostatic Cycling Data

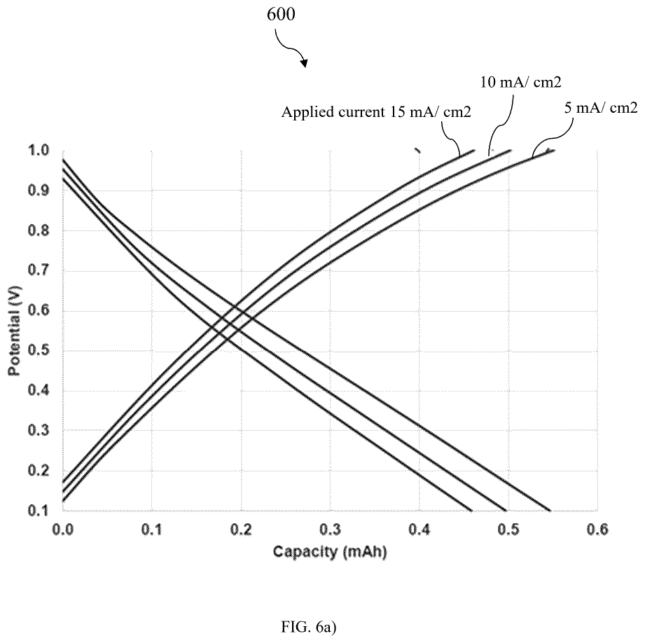

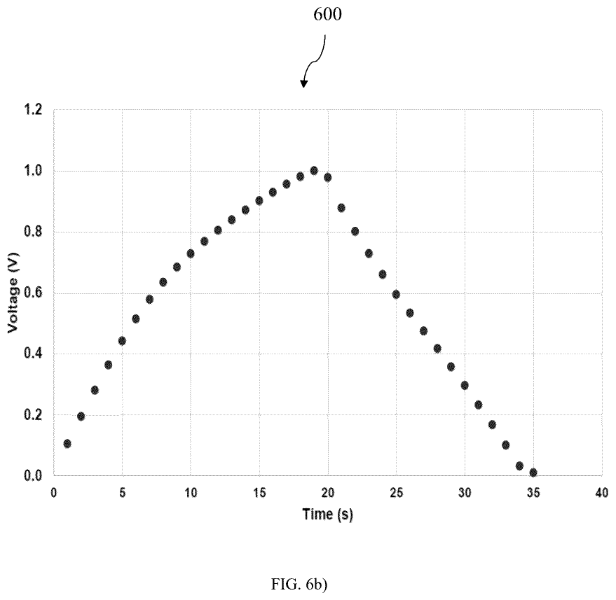

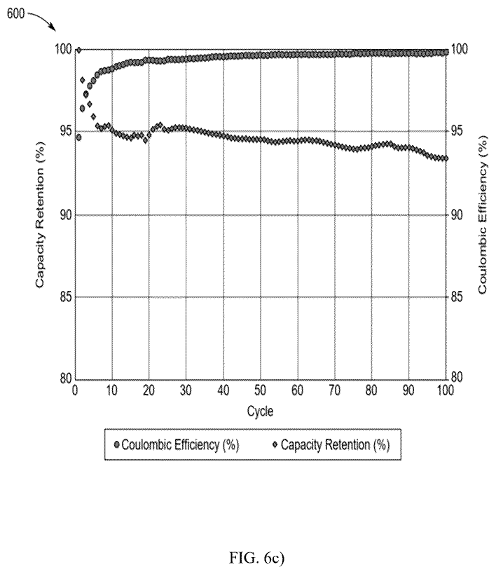

The galvanostatic refers to an experimental technique where an electrode is maintained at a constant current in the electrolyte. This technique is used to measure corrosion rate and electrochemical reactions. 15 mA/cm², 10 mA/cm², and 5 mA/cm² current applied for measuring galvanostatic cycling data (shown in FIG. 6).

FIG. 6 is representation of galvanostatic cycling data of the electrode a) Potential vs Capacity, b) Voltage vs Time, and c) Coulombic efficiency (%) vs Capacity retention (%), in accordance with an embodiment of the present invention. Galvanostatic charge-discharge GCD (FIG. 6a) profile having a triangular-symmetrical voltage profile without any plateau (FIG. 6b) represent an electric double layer capacitive behaviour. The rate capability of the electrode is investigated using the GCD technique. High coulombic efficiency with high-capacity retention (FIG. 6c) even after a long cycle proves the robustness of the electrode.

The present invention is explained further in the following specific examples which are only by way of illustration and are not to be construed as limiting the scope of the invention.

### Example 1: Electrode Material Preparation

General Composition (by wt. %): activated carbon (50-70%), conductive carbon black (20-40%), milled carbon fiber (5 to 10%), and PTFE binder (0.5 to 2%).

Arrangement of Solvent:Water:Ethanol=8:2 (Volume ratio). For 1 kg of Cathode mixture, 10 L (Water 8 L & Ethanol 2 L) of solvent required (i.e., 1:10 Wt:Vol ratio).

Process: The necessary amount of water and ethanol were taken in the (commercially available) planetary mixer. The required amount (1.5%) of PTFE binder (INFOLON AD9300 from GFL) was added to the mixture, mixed well (made sure that the binder dispersed uniformly throughout the solution) to obtain a homogeneous dispersion. The solid mixture is prepared by adding the required amount of activated carbon (65%), conductive carbon black (25%) and milled carbon fiber (8.5%) in a dry container and mixed uniformly (and gently). The homogeneous dispersion and the solid mixture were mixed for 2 hours in the planetary mixer by maintaining speed of the blade and the cathode mixture was prepared. The cathode mixture was dried while mixing.

### Example 2: Preparation of Cathode Electrode Sheet

Process: Mixed the dry electrode mixture with ethanol uniformly (electrode mixture (g):ethanol (ml)=1:2.5). Prepared a cylindrical block using a hydraulic press at critical pressure. Extruded out the paste and put through two mill rollers to make sheets (thickness 2 to 5 mm). Dried the sheet at 50° C. until all solvent is evaporated.

### Example 3: Preparation of Anode Electrode Sheet

Process: Mixed the dry electrode mixture with ethanol uniformly (electrode mixture (g):ethanol (ml)=1:3.5). Prepared a cylindrical block using a hydraulic press at critical pressure. Extruded out the paste and put through two mill rollers to make sheets (0.1 to 2 mm). Dried the sheet at 50° C. until all solvent is evaporated.

The present invention provides the electrode for the redox battery. The electrode is highly conductive mainly due to the uniform distribution of the conductive carbon black. The electrode has high surface area compared to conventional electrode, due to the use of optimized activated carbon (SSA: ~1900 m²/g). The electrode includes use of minimum quantity (even 1 wt. %) nonconductive polymer binder which minimizes dead mass and enhances capacity as well as energy density (almost 99 wt. % is active material in the electrode). The use of milled carbon fiber in the electrode ensures formation of the composite matrix and provides desirable mechanical strength, flexibility and load resistance capabilities. The present invention also provides the process for preparing the electrode for the redox battery. The process provided by the present invention is simple, cost-effective, and scalable. The process eliminates complex steps such as ball-milling of raw carbon materials or crushing of carbon fiber from conventional process, thus making it more convenient to follow. The process enables achieving tunable electrochemical, mechanical and physical properties of the electrode.

While specific language has been used to describe the invention, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. An electrode for a redox battery, comprising:
an electrode sheet, wherein the electrode sheet comprises one of a cathode electrode sheet and an anode electrode sheet,
wherein the cathode electrode sheet comprises an electrode mixture with a solvent in a wt:vol ratio ranging from 1:2 to 1:3,
wherein the anode electrode sheet comprises the electrode mixture with the solvent in a wt:vol ratio ranging from 1:3 to 1:4, and
wherein the electrode mixture comprises 50-70 wt % of activated carbon, 20-40 wt % of conductive carbon black, 1 to 10 wt % of milled carbon fiber and 0.5 to 2 wt % of PTFE binder.

2. The electrode as claimed in claim 1, wherein the cathode electrode sheet comprises a thickness of 2 to 5 mm.

3. The electrode as claimed in claim 1, wherein the anode electrode sheet comprises a thickness of 0.1 to 2 mm.

4. The electrode as claimed in claim 1, wherein the electrode mixture preferably comprises 65 wt % of activated carbon, 25 wt % of conductive carbon black, 8.5 wt % of milled carbon fiber and 1.5 wt % of PTFE binder.

5. The electrode as claimed in claim 1, wherein the solvent is selected from a group consisting of ethanol, isopropanol, and a combination thereof.

6. The electrode as claimed in claim 1, wherein the cathode electrode sheet preferably comprises the electrode mixture with the solvent in the wt:vol ratio of 1:2.5.

7. The electrode as claimed in claim 1, wherein the anode electrode sheet preferably comprises the electrode mixture with the solvent in the wt:vol ratio of 1:3.5.

8. The electrode as claimed in claim 1, wherein the electrode is configured to exhibit enhanced mechanical strength, flexibility and load resistance capabilities.

9. A process for preparing an electrode for a redox battery, comprising:
a) adding 1.5 wt % of PTFE binder to a first solvent to obtain a homogeneous dispersion;
b) mixing 50-70 wt % of activated carbon, 20-40 wt % of conductive carbon black and 1 to 10 wt % of milled carbon fiber to obtain a solid mixture;
c) uniformly mixing the homogeneous dispersion and the solid mixture for a duration of 2 hours to obtain an electrode mixture;
d) drying the electrode mixture at 120° C. for a duration of 12 hours;
e) mixing the dried electrode mixture with a second solvent in a predefined ratio to obtain an electrode paste,
wherein the predefined ratio is a wt:vol ratio ranging from 1:2 to 1:3 to obtain a cathode electrode paste,
wherein the predefined ratio is a wt:vol ratio ranging from 1:3 to 1:4 to obtain an anode electrode paste;
f) subjecting the electrode paste to compaction to obtain an electrode sheet; and
g) drying the electrode sheet at 50 to 65° C. for a duration of 12 hours to obtain the electrode for the redox battery.

10. The process as claimed in claim 9, wherein the first solvent comprises water and one of ethanol and isopropyl alcohol in a volume ratio of 8:2.

11. The process as claimed in claim 9, wherein the step (b) preferably comprises mixing of 65% of activated carbon, 25% of conductive carbon black and 8.5% of milled carbon fiber to obtain the solid mixture.

12. The process as claimed in claim 9, wherein the second solvent is selected from a group consisting of ethanol, isopropanol, and a combination thereof.

13. The process as claimed in claim 9, wherein the cathode electrode paste is subjected to compaction using hydraulic press followed by a roller to obtain a cathode electrode sheet.

14. The process as claimed in claim 13, wherein the cathode electrode sheet comprises a thickness of 2 to 5 mm.

15. The process as claimed in claim 9, wherein the anode electrode paste is subjected to compaction using the hydraulic press followed by the roller to obtain an anode electrode sheet.

16. The process as claimed in claim 15, wherein the anode electrode sheet comprises a thickness of 0.1 to 2 mm.
